(19) United States
(12) Patent Application Publication
(10) Pub. No.: US 2002/0053544 A1
(43) Pub. Date: May 9, 2002

(54) Novel composite membrane

(76) Inventors: Robert Y.M. Huang, Waterloo (CA); Rajinder Pal, Waterloo (CA); Go Young Moon, Kitchener (CA)

Correspondence Address: GOWLING LAFLEUR HENDERSON LLP, SUITE 4900, COMMERCE COURT WEST, TORONTO, ON, M5L 1J3, CA

(21) Appl. No.: 09/948,677

(22) Filed: Sep. 10, 2001

Related U.S. Application Data
(63) Continuation of application No. PCT/CA00/00254, filed on Mar. 10, 2000.

(30) Foreign Application Priority Data
Mar. 11, 1999 (CA) 2,265,390

(51) Int. Cl. B01D 29/31; B01D 61/00

(52) U.S. Cl. 210/650; 210/483; 210/488; 210/490

(57) ABSTRACT

A composite membrane is provided having a first layer and a second layer, the first layer comprising an alginic acid or a salt of alginic acid, or a salt of a derivative of an alginic acid, and the second layer comprising a non-porous polymer with at least one hydrophilic functional group and adapted to provide mechanical support and reinforcement of the first layer. The second layer is selectively water permeable and can comprise water insoluble polymers such as chitosan, chitosan derivatives and cellulose derivatives. The second layer can also comprise water soluble polymers so long as such polymers are adequately crosslinked. Where the second layer comprises chitosan, each of the alginic acid or the salt of an alginic acid or the salt of a derivative of an alginic acid of the first layer and the chitosan of the second layer can be crosslinked separately by immersing in a formaldehyde solution. The thickness of the first layer is from about 0.5 microns to about 20 microns. The thickness of the second layer is from about 1.0 microns to about 40 microns. The ratio of the thickness of the first layer to the second layer is from about 1:1 to 1:5.

### FIELD OF INVENTION

The present invention relates to novel composite membrane material, and, more particularly, novel composite pervaporation and reverse osmosis membranes.

### BACKGROUND OF THE INVENTION

In recent years, there has been increased interest in the use of pervaporation membrane separation techniques for the selective separation of organic liquid mixtures because of their high separation efficiency and flux rates coupled with potential savings in energy costs.

Pervaporation is the separation of liquid mixtures by partial vaporization through a non-porous permselective membrane. During its transport through the membrane, components of the liquid mixture diffusing through the membrane undergo a phase change, from liquid to vapor. This phase change occurring through the membrane makes the pervaporation process unique among membrane processes. The permeate, or product, is removed as a low-pressure vapor, and, thereafter, can be condensed and collected or released as desired.

In a typical pervaporation process, a liquid mixture feed is contacted with one side of a dense non-porous membrane. After dissolving in and diffusing through the membrane, the permeate is removed from the downstream side in the vapor phase under vacuum or swept out in a stream of inert carrier gas. Separation of individual components of the liquid mixture feed requires that physicochemical interactions with the membrane be different for the individual components. Such interactions affect the permeation rate of each of the individual components through the membrane, thereby giving rise to separation.

Membrane performance in the pervaporation context is measured by its selectivity. The selectivity of a membrane for the separation of a mixture comprised of components A and B may be described by the separation factor ∝ which is defined as follows:

$$∝ = ( \frac{Y}{1 - Y} ) ( \frac{1 - X}{X} )$$

where X and Y are the molar fractions of the more permeable component A in the feed and permeate, respectively. In addition to being selective, however, it is desirable for a membrane to have good permeability. Otherwise, despite high selectivity, acceptable separations will not be achieved where the membrane is relatively impermeable for components in the liquid feed.

Common applications of pervaporation include the dehydration of alcohol and organic solvents, and the removal of organic solvents from water. Dehydration of alcohols is presently the best-developed area of application. For the dehydration of alcohol mixtures, polymeric membranes containing hydrophilic groups are preferred. Hydrophilic groups have an affinity for water molecules, and therefore provide for high fluxes and high separation factors in dehydration applications. However, hydrophilic groups tend to cause significant swelling of the membrane, resulting in low selectivity.

Due to their high water permselectivity and solvent stability, chitosan membranes have often been used for dehydration applications. Chitosan is the deacetylated form of chitin, which is the second most abundant biopolymer in nature. Chitosan has both reactive amino and hydroxyl groups that can be used for chemical reactions and salt formation. These hydrophilic groups are believed to play an important role in preferential water sorption and diffusion through the chitosan membrane.

Chitosan membranes have been studied for the dehydration of alcohols (M Ghazali M. Nawawi and Robert Y. M. Huang, Pervaporation Separation of Isopropanol-water Systems Using Chitosan-polyvinyl Alcohol Blend Membranes, Journal of Membrane Science, 124, @ pp. 53-62, 1997; J. J. Shieh and Robert Y. M. Huang, Pervaporation with Chitosan Membranes II Separation of Ethanol-water Mixtures Using Chitosan-polyacrylic Composite Membranes, Journal of Membrane Science, 127, @ pp. 185-202, 1997) and pervaporation separation of ethylene glycol from aqueous solutions (Xianshe Feng and Robert Y. M. Huang, Estimation of Activation Energy for Permeation in Pervaporation Processes, Journal of Membrane Science, 118, @ pp. 127-131, 1996a). Chitosan has been shown to have good film forming properties, chemical resistance and high permselectivity for water.

Alginate, which is one of the polysaccharides found in seaweeds, has also been found to have excellent performance as a pervaporation membrane material for the dehydration of ethanol-water mixture, largely owing to its hydrophilic functional groups. However, in aqueous solutions, alginate is a relatively unstable pervaporation membrane and has a wet strength which is weak. This appears to be attributable to alginate's very high hydrophilicity, owing to the carboxylic and hydroxyl groups present in the molecule (C. Y. Yeom, K. H. Lee, Characterization of Relaxation Phenomena and Permeation Behaviors in Sodium Alginate Membrane during Preparation Separation of Ethanol-Water Mixture, J. Appl. Polym. Sci. 62 (1996) 1561-1576). Notably, it has been pointed out that alginate membranes are not strong enough to operate in the aqueous solutions of 50 wt. % ethanol (A. Mochizuki, S. Amiya, Y. Sato, H. Ogawara, S. Yamashita, Pervaporation Separation of Water/Ethanol Mixtures through Polysaccharide Membranes IV, The Relationship between the Permselectivity ofAlginic Acid Membrane and its Solid State Structure, J. Appl. Polym. Sci. 40 (1990) 385-400). In this respect, mechanical weakness of alginate membranes has been a drawback in its possible use as a pervaporation material in spite of its excellent permselectivity for water.

Attempts have been made to mitigate the mechanical weakness of sodium alginate by cross-linking with glutaraldehyde (C. K. Yeom and K. H. Lee, Characterization of Sodium Alginate Membrane Crosslinked with Glytaraldehyde in Pervaporation Separation, J. Appl. Polym. Sci 67 (1998) 209-219)and blending with polyvinyl alcohol (“PVA”) (J. G. Jegal and K. H. Lee, Pervaporation Separation of Water-Ethanol Mixtures through PVA-Sodium Alginate Blend Mixtures, J. Appl. Polym. Sci. 61 (1996) 389-392). However, the benefits derived from cross-linking are known to be impermanent (Y. Maeda and M. Kai, Recent Progress in Pervaporation Membranes for Water/Ethanol Separation, in: R. Y. M. Huang (ed.), Pervaporation Membrane Separation Process, Elsevier, Amsterdam, 1991 @ p.391). Furthermore, blending of alginate with PVA affects the membrane separation factor.

Reverse osmosis membranes including metallic divalent cation-crosslinked sodium alginate membranes having surface sites complexed with chitosan are taught in C. K. Yeom et al, Recovery of Anionic Surfactant by RO process. Part 1Preparation of Polyelectrolyte-complex Anionic Membrane, Journal of Membrane Science 143 (1998) 207-218. The publication does not suggest ways to provide structural reinforcement to an inherently mechanically weak sodium alginate membrane. Rather, the publication discloses the fact that washing out of a metallic divalent cation-crosslinking agent from a sodium alginate membrane may be mitigated by compeering surface sites of the sodium alginate membrane with chitosan. However, there is no structural support function provided by the chitosan. Notably, this publication discloses that increasing chitosan deposits on the surface of the sodium alginate membrane is detrimental to the functioning of the membrane.

Alginate membranes are known to be fragile, yet there is no disclosure of an alginate based membrane that exhibits increased mechanical strength while maintaining the desired alginate properties of the alginate membrane itself. There is a need in the art to provide a pervaporation membrane that exhibits desired properties of an alginate, but that is more stable and stronger than alginate. The present invention is directed to composite membranes having mechanical strength for use in separating liquids.

### SUMMARY OF INVENTION

The present invention is directed to a composite membrane having a first layer comprising a salt of an alginic acid which is mechanically reinforced by a second layer.

According to one aspect of the present invention, a composite membrane is provided having a first layer and a second layer, the first layer comprising an alginic acid or a salt of an alginic acid or a salt of an alginic acid derivative, and the second layer comprising a non-porous polymer having hydrophilic properties and adapted to provide mechanical support and reinforcement to the first layer. The non-porous polymer of the second layer can be water insoluble, examples of such non-porous polymers include chitosan and chitosan derivatives, and cellulose and cellulose derivatives. The non-porous polymer of the second layer can also be water soluble, and can include crosslinked polyvinyl alcohol. The alginic acid or the salt of an alginic acid or the salt of an alginic acid derivative can be crosslinked. Similarly, the non-porous polymer of the second layer can also be crosslinked.

A further aspect of the invention provides a method for the separation of an aqueous mixture having a water concentration of greater than 50% by weight, the method comprising the steps of providing a composite membrane having a first layer and a second layer, the first layer comprising an alginic acid or a salt of an alginic acid or a salt of an alginic acid derivative, the second layer comprising a non-porous polymer having hydrophilic properties; and contacting the mixture with a surface of the first layer.

In another aspect, the present invention provides a method of preparing a composite membrane having a first layer and a second layer, the first layer comprising an alginic acid or a salt of an alginic acid or a salt of an alginic acid derivative, and the second layer comprising a non-porous polymer having hydrophilic properties and adapted to provide mechanical support and reinforcement to the first layer, comprising the steps of casting a first film comprising an aqueous solution of an alginic acid or salt of an alginic acid or a salt of a derivative of an alginic acid, casting a second film comprising an aqueous solution having a non-porous polymer with at least one hydrophilic functional group, on a surface of the film to form a first intermediate, and drying the first intermediate. The alginic acid or the salt of an alginic acid or the salt of an alginic acid derivative of the first film can further be crosslinked. Similarly, the non-porous polymer of the second film can also be crosslinked. The non-porous polymer can be a chitosan-acid salt. In this respect, an additional step is required to transform the chitosan-acid salt into a free amine form of chitosan after drying of the first intermediate. The transformation can be effected after drying of the first intermediate by immersing the dried first intermediate in an alkaline solution to form a second intermediate, and drying the second intermediate.

In yet a further aspect, the invention provides a composite membrane having a first layer and a second layer, the first layer comprising an alginic acid or a salt of an alginic acid or a salt of an alginic acid derivative, and the second layer comprising a non-porous polymer having hydrophilic properties, wherein the first layer has a thickness of about 0.5 micros to about 20 microns and the second layer has a thickness of about 1.0 microns to about 40 microns. The ratio of the thickness of the first layer to the thickness of the second layer is about 1:1 to about 1:5.

In yet another aspect, the present invention provides a method for the separation of an aqueous mixture having a water concentration of greater than 50% by weight, the method comprising the steps of providing a composite membrane having a first layer and a second layer, the first layer comprising an alginic acid or a salt of an alginic acid or a salt of an alginic acid derivative, and the second layer adapted to provide mechanical support and reinforcement to the first layer, and contacting said mixture with said first layer.

Membranes comprised of a salt of alginic acid or a salt of an alginic acid derivative are known to be mechanically weak. Despite being disposed to selective permeation of water, such membranes inordinately swell when contacted with water, thereby becoming mechanically vulnerable to hydrodynamic stresses experienced during a typical pervaporation process unit operation. The second layer of the present invention, when coated with a first layer comprised of a salt of alginic acid or a salt of an alginic acid derivative, provides reinforcement to the first layer such that the resulting composite membrane is sufficiently strong for use as a pervaporation membrane.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a schematic diagram of the pervaporation apparatus used in Examples 1 and 2.

FIG. 2 is a graph illustrating flux of aqueous ethanol solution as a function of ethanol feed concentration during pervaporation of aqueous ethanol solution through each of a double layer membrane of the present invention, a pure alginate membrane and a pure chitosan membrane.

FIG. 3 is a graph illustrating separation factor of aqueous ethanol solution as a function of ethanol feed concentration during pervaporation of aqueous ethanol solution through each of a double layer membrane of the present invention, a pure alginate membrane and a pure chitosan membrane.

FIG. 4 is a graph illustrating flux of aqueous isopropanol solution as a function of isopropanol feed concentration during pervaporation of aqueous isopropanol solution through each of a double layer membrane of the present invention, a pure alginate membrane and a pure chitosan membrane.

FIG. 5 is a graph illustrating separation factor of aqueous isopropanol solution as a function of isopropanol feed concentration during pervaporation of aqueous isopropanol solution through each of a double layer membrane of the present invention, a pure alginate membrane and a pure chitosan membrane.

FIG. 6 is a Scamiing Electron Micrograph photograph of a double layer membrane comprising a first layer having sodium alginate and a second layer having chitosan.

### DETAILED DESCRIPTION

The present invention relates to a novel composite membrane material, and, more particularly, novel composite pervaporation and reverse osmosis membranes.

The composite membrane of the present invention comprises two distinct layers. The first layer is exposed to the solution to be separated. The components of the solution dissolve and permeate through the first layer and then through the second layer. The components of the solution become separated by virtue of the different permeabilities of the components through the membrane.

The first layer may be comprised of an alginic acid or a salt of an alginic acid such as sodium alginate or potassium alginate. Alternatively, the first layer can comprise of a salt of an alginic acid derivative, such as partially methylesterified alginic acid, carbomethoxylated alginic acid, phosphorylated alginic acid or aminated alginic acid. Membranes comprised of these compounds are very permselective with respect to water, but are mechanically weak, and in particular, possess a wet strength which is weak, and therefore require adequate reinforcement for use in pervaporation process unit operations.

The second layer provides mechanical support and reinforcement of the first layer. It is comprised of a non-porous polymer having hydrophilic properties and is adapted to provide mechanical support and reinforcement of the first layer. Suitable hydrophilic functional groups which provide hydrophilic properties to the polymer of the second layer include amine groups, hydroxyl groups, carboxyl groups, acetyl groups, and sulphone groups.

The characteristic polymer of the second layer should have good film forming properties. In this respect, the polymer should be more elastic rather than rigid. Without these characteristics in the second layer, the composite membrane will not be adequately robust to sustain its mechanical integrity during periods of substantial swelling and high temperature operation.

The second layer can be comprised of a non-porous polymer having hydrophilic properties, which is adapted to provide mechanical support and reinforcement to the first layer, and which is either soluble or insoluble in aqueous solutions. Preferably, the characteristic polymer of the second layer is water insoluble. Water insoluble polymers tend to resist swelling and, therefore, maintain their mechanical support and reinforcement properties. Examples of acceptable water insoluble polymers for use in the second layer include chitosan and chitosan derivatives such as N-acylchitosan, N-carboxyalkyl-chitosan and N-carboxyacylchitosan, and cellulose and cellulose derivatives such as cellulose acetate and cellulose triacetate. Preferably, the water insoluble polymer of the second layer is chitosan.

Where the characteristic polymer of the second layer is water soluble, however, the polymer must be adequately crosslinked with a suitable crosslinking agent to preserve its mechanical support and reinforcement characteristics. Examples of suitable water soluble polymers include polyvinyl alcohol. Where polyvinyl alcohol is used, the polyvinyl alcohol must be crosslinked with a suitable crosslinking agent such as maleic acid.

Where the second layer is comprised of chitosan, it is preferable to use a chitosan having an effective deacetylation degree such that there are sufficient amino groups to effect adequate permeation of water. Preferably, the deacetylation degree is at least about 70%, and more preferably greater than 90%. Further, it is preferable to use a chitosan having an effective molecular weight to create a second layer which is adequately strong yet is not difficult to prepare. Preferably, the chitosan has a molecular weight of about 50,000 to about 1,000,000.

The complementary surfaces of the first and second layers interact to create a composite, asymmetric membrane. Preferably, such interaction does not compromise the permeation of water as it diffuses into the second layer from the first layer. Where the second layer is comprised of chitosan, it is believed that there is no permanent chemical change in either of the complementary surfaces of the first and second layers when the second layer is deposited on the first layer.

In one embodiment, each of the alginic acid the salt of an alginic acid or the salt of an alginic acid derivative of the first layer is crosslinked and the polymeric material of the second layer is crosslinked. Crosslinking is desirable in order to increase the water resistance and mechanical strength of each of the layers of the composite membrane of the present invention. To provide for crosslinking in both layers, a crosslinking agent suitable for materials in both layers must be used. In the embodiment where the second layer comprises chitosan, a suitable crosslinking agent includes formaldehyde solution. However, it is to be understood that the materials of the first layer do not have to be crosslinked in order for the composite membrane to function in separating aqueous solutions. In the same vein, the materials of the second layer do not necessarily have to be crosslinked.

The first layer of the composite membrane has a thickness of about 0.5 microns to about 20 microns. The second layer must have an effective thickness to provide adequate mechanical reinforcement to the first layer. Preferably, the second layer has a thickness of about 1.0 microns to about 40 microns and the ratio of thickness of the first layer to the thickness of the second layer is from about 1:1 to about 1:5.

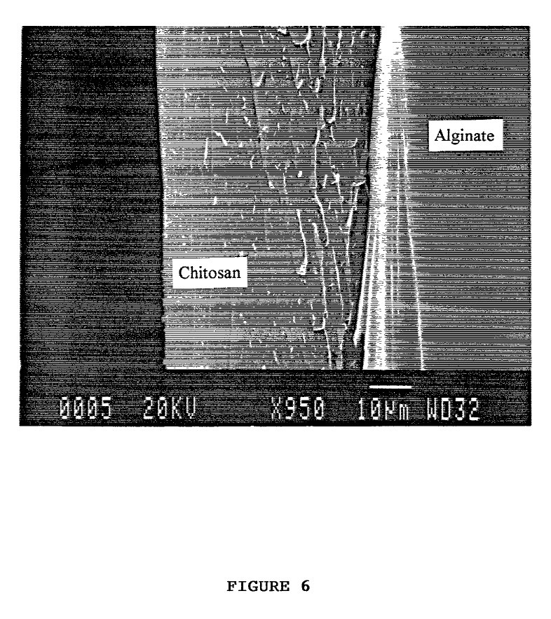

A SEM photograph of a double layer membrane comprising a first layer having sodium alginate and a second layer having chitosan is illustrated in FIG. 6. The thickness of the double layer membrane that is illustrated is 40-50 microns, where the thickness of the first layer, or the alginate layer, is less than 10 microns.

The composite membrane of the present invention can be prepared by a wet process which comprise the successive casting of a solution of an alginic acid or a salt of an alginic acid, such as sodium alginate, or a salt of a derivative of alginic acid, and a solution of a dense non-porous polymer having hydrophilic properties and adapted to provide mechanical support and reinforcement for the composite membrane.

By way of example, the following describes a method of preparing a double layer membrane, where the first layer is comprised of sodium alginate and the second layer is comprised of chitosan. As a first step, sodium alginate solution can be cast onto a suitable casting surface, usually with the assistance of a suitable casting knife to control the thickness of the membrane, to form the first layer. Second, a dilute acid solution of chitosan is cast onto the alginate solution layer, again, usually with the assistance of a suitable casting knife. Chitosan is insoluble in water. However, in some acid solutions (eg. acetic acid), the free amino groups in chitosan become protonated to form water-soluble chitosan-acid salts. Once cast, the resulting membrane is then dried. Once dried, this first intermediate is immersed in an alkaline solution to convert the cationic amine groups back into free amino form, thereby accomplishing regeneration of chitosan in free amino form. This second intermediate is then washed thoroughly to remove the alkaline solution, dried again, and then immersed in a crosslinking solution.

The composite membrane of the present invention is useful in the pervaporation separation of alcohol-water mixtures, such as ethanol-water mixtures and isopropanol-water mixtures. In addition, the membrane may be used for the pervaporation separation of organic solvents-water mixtures such as ethylene glycol-water mixtures and pyridine-water mixtures. Further, the membrane can also be used for reverse osmosis separations of aqueous mixtures as the transport processes involved are similar to those of pervaporation.

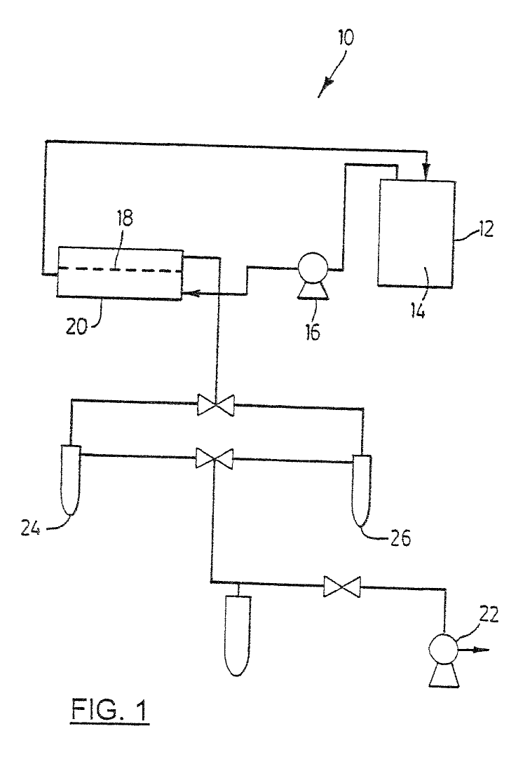

A schematic diagram of a pervaporation apparatus 10 used in the illustrative examples described below is shown in FIG. 1. The feed solution temperature in the tank 12 was controlled to the desired value, and the feed solution 14 is circulated using the feed pump 16. The membrane was placed on the porous stainless steel support 18 of the membrane cell 20 and sealed. The effective area of the membrane in contact with the feed stream was 14.2 cm². Pervaporation was initiated by switching on the circulation pump 16 and vacuum pump 22, the pressure at permeate side was maintained around 3 mbar. Permeate was collected in the cold trap 24 which were immersed in liquid nitrogen. The pervaporation apparatus 10 was run for at least 2 hours to reach the equilibrium state before starting to measure permeate. When sufficient permeate was collected in the cold trap 24, the vacuum valve 28 was switched to the parallel trap 26 to collect a further sample. The cold trap 24 containing the permeate was warmed up to ambient temperature, then removed, and weighed to determine the flux and the contents were analysed for permeate composition.

Using this pervaporation apparatus, composite membranes having a first layer comprising sodium alginate and a second layer comprising chitosan were shown to have good pernselectivity, similar to that of an alginate polymer, and to be mechanically stable during alcohol dehydration operations. Notably, such double layer membranes were shown to have relatively good water selectivity and maintained their mechanical integrity when exposed to aqueous mixtures having concentrations of well over 50wt % water.

The present invention will be described in further detail with reference to the following non-limitative examples.

### EXAMPLE 1

Sodium alginate was dissolved in water to form a homogeneous solution of 1.2 wt %, although a solution of about 0.5 wt % sodium alginate to about 3.0 wt % sodium alginate would also have been acceptable. Chitosan solution was prepared by dissolving 1.2 wt % chitosan in 10 wt % aqueous acetic acid solution. Aqueous acetic acid solutions having about 0.5 wt % chitosan to about 3.0 wt % chitosan would also have been acceptable. With respect to concentration of both sodium alginate and chitosan in their respective solutions, a limiting factor is the resultant viscosity of the solution which could affect casting of acceptably thin films.

Both sodium alginate and chitosan solutions were filtered to remove any undissolved solids and impurities. First, sodium alginate solution was cast onto a glass plate with the aid of a casting knife, in succession, chitosan solution was cast onto the alginate solution layer. It is believed that there is no significant reaction between them because each layer can be separated after swelling with water. The resulting membrane was dried at room temperature for 24 hours. The thickness of the resulting membrane was 40-50 microns, where the thickness of the sodium alginate layer was less than 10 microns. The dried membrane was peeled off from the plate, and then immersed in a treatment solution. For this example, the treatment solution consisted of 3 % H₂SO₄ in 50 wt % acetone aqueous solution. This double layer membrane was immersed for 12 hours in this solution. Without wishing to be limited by theory, it is believed that the sodium alginate of the first layer becomes converted to alginic acid, which is less water soluble than sodium alginate. It is believed that the chitosan of the second layer was crosslinked by virtue of the immersion in the H2SO₄ solution. In both cases, membrane susceptibility to swelling is reduced, albeit for different reasons.

Pure alginate and chitosan membranes were prepared also using the above-described casting method. With respect to the pure alginate membrane, sodium alginate was cast onto a glass plate with the casting knife. With respect to the pure chitosan membrane, chitosan solution was cast onto a glass plate with the casting knife. Both resulting membranes were dried at room temperature for 24 hours. With respect to the chitosan, once dried, this membrane was subsequently treated in 3 wt % NaOH solution containing 50 wt % ethanol solution for 24 hours at room temperature, washed thoroughly to completely remove NaOH, and then dried again at room temperature.

Separation factor was calculated by the following equation:

∝_{water/alcohol}=[Y_{W}/ Y_{A}]/[X_{W}/X_{A}]

Where X and Y are the weight fractions of the feed and permeate, respectively. Analysis of the permeate composition was carried out by using HP 5890 Gas Chromatography with a FID detector and Abbe Refractometer type 3T at 26.7° C. The column used in the gas chromatographic analysis was 6′×0.125′ packed with Porapak T.

Pervaporation experiments were carried out for ethanol-water mixtures using each of the double layer membrane, the pure alginate membrane and the pure chitosan membrane. The concentration of alcohol was varied from 70 to 95 wt %. The alginate-chitosan double layer membranes were found to be mechanically stable during the alcohol dehydration runs and did not deteriorate due to the additive strength of the chitosan layer of the two ply membrane.

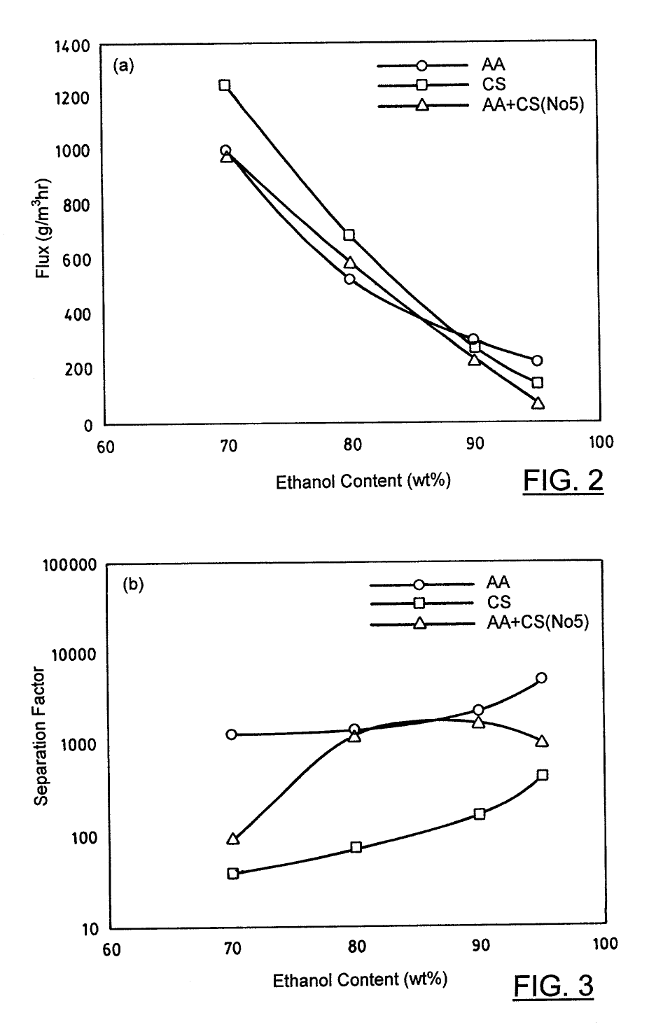

FIGS. 2 and 3 show the pervaporation results at various ethanol concentrations of the double layer membranes together with the pervaporation results of pure alginate and chitosan membranes. The alginate membrane shows higher flux than that of the chitosan membrane at feed concentrations of 90% and 95% ethanol. At azeotropic composition of ethanol and water mixture a flux of 220 g/m²-hr and a separation factor of 5570 is achieved for the alginate membrane. This suggests that alginate is an extremely water permselective material.

The double layer membrane had lower fluxes than those of alginate and chitosan membranes. At azeotropic concentration of the feed, the flux and separation factor of the double layer membrane reaches 70 g/m²-hr and 1110 μm²- hr respectively. More generally, across the entire range of ethanol feed concentration studied, the separation factors of the double layer membrane lie between those of alginate and chitosan.

### EXAMPLE 2

A second double layer membrane was prepared in similar manner as the double layer membrane in Example 1, with the exception that the treatment solution was a solution of a crosslinking agent which consisted of a formaldehyde solution prepared with 6% formaldehyde, 0.5% HCI catalyst in 50% aqueous acetone solution. The double layer membrane was immersed in the formaldehyde crosslinking solution for 24 hours.

Pervaporation experiments, similar to those described in Example 1, were carried out for isopropanol-water mixtures using the second double layer membrane, a pure alginate membrane, and a pure chitosan membrane. The concentration of the isopropanol-water feed mixture was varied from 70 to 95 wt %.

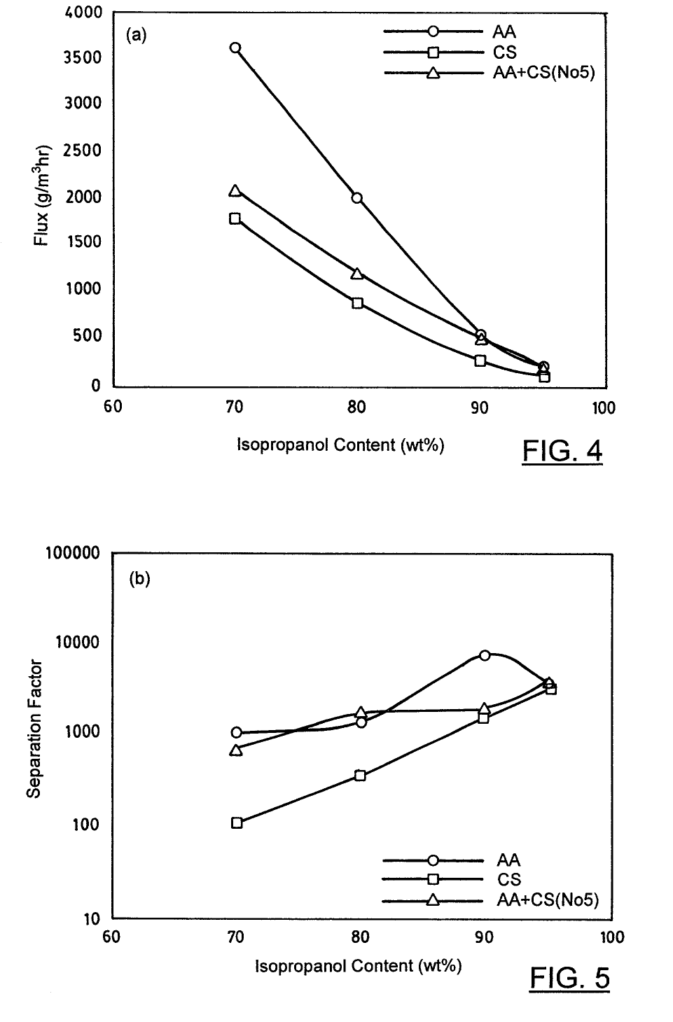

FIGS. 4 and 5 show the pervaporation results conducted at various isopropanol concentrations at 60° C. for the second double layer membrane, pure alginate membrane and pure chitosan membrane. The second double layer membrane was treated in the formaldehyde solution and the alginate side contacted the feed stream. As illustrated in FIG. 3a, the flux performance of the two-ply membrane is analogous to that of pure alginate at 95% and 90% propanol concentrations. Without wishing to be bound by theory, it is believed that crosslinking associated with formaldehyde solution does not inhibit membrane swelling to the degree experienced when immersing the membrane of Example 1 in H₂SO₄ solution.

### EXAMPLE 3

The double layer membrane of Example 1 was used in pervaporation experiments carried out for ethanol-water and isopropanol-water mixtures having feed concentrations ranging from 50 wt % water to 90 wt % water. The operating temperature was 60° C., and the results are presented in Table 1. The membranes maintained their integrity even for 90% water mixtures and showed good water selectivities.

TABLE 1

| Alcohol | Ethanol | | | Isopropanol | | |
|---|---|---|---|---|---|---|
| content in | | EtOH | | | PrOH | |
| the feed | Flux | content in | Separation | Flux | content in | Separation |
| (wt %) | (g/m² hr) | the permeate | factor | (g/m² hr) | the permeate | factor |
| 50% | 4742 | 22.87% | 3.4 | 3947 | 3.4% | 28 |
| 30% | 7345 | 8.3% | 4.7 | 5833 | 1.5% | 27.8 |
| 10% | 9893 | 1.1% | 10 | 8991 | 0.55% | 20 |

### EXAMPLE 4

The double layer membrane of Example 2 was used in pervaporation experiments carried out for ethanol-water and isopropanol-water mixtures having feed concentrations ranging from 50 wt % water to 90 wt % water. The operating temperature was 60° C. The experimental results are presented in Table 2. The membranes maintained their integrity across the range of feed water concentrations studied.

The permeation fluxes through formaldehyde crosslinked membrane are higher than those of sulphuric acid treated membrane of Example 3. Not surprisingly, separation factors were markedly reduced for feed mixtures with high water content.

TABLE 2

| Alcohol | Ethanol | | | Isopropanol | | |
|---|---|---|---|---|---|---|
| content in | | EtOH | | | PrOH | |
| the feed | Flux | content in | Separation | Flux | content in | Separation |
| (wt %) | (g/m² hr) | the permeate | factor | (g/m² hr) | the permeate | factor |
| 50% | 7,408 | 14.652% | 5.8 | 6,108 | 2.899% | 33.5 |
| 30% | 12,124 | 9.484% | 4.1 | 8,756 | 5.685% | 7.1 |
| 10% | 23,205 | 5.265% | 2 | 18,679 | 3.092% | 3.5 |

In view of the above-described experimental results, it has been shown that the superior permselectivity of alginate polymer can be applied to a pervaporation membrane in the form of a two-ply dense membrane which can maintain its mechanical integrity under the hydrodynamic and temperature conditions typically experienced during pervaporation unit operations.

All references herein are incorporated by reference.

It will be understood, of course, that modifications can be made in the embodiments of the invention described herein without departing from the scope and purview of the invention. For a complete definition as to the scope of the invention, reference is to be made to the appended claims.

We claim:

1. A composite membrane including a first layer and a second layer, said first layer comprising an alginic acid or a salt of an alginic acid or a salt of an alginic acid derivative, and said second layer comprising a non-porous polymer having hydrophilic properties and adapted to provide mechanical support and reinforcement to said first layer.

2. The membrane of claim 1 wherein said non-porous polymer of said second layer is water insoluble.

3. The membrane of claim 1 wherein said non-porous polymer of said second layer is water soluble.

4. The membrane of claim 2 wherein said second layer comprises a non-porous polymer selected from the group consisting of chitosan and chitosan derivatives, and cellulose and cellulose derivatives.

5. The membrane of claim 3 wherein said non-porous polymer is a crosslinked polyvinyl alcohol.

6. The membrane of claim 1 wherein said non-porous polymer of said second layer is chitosan.

7. The membrane of claim 1 wherein said alginic acid or said salt of an alginic acid or said salt of an alginic acid derivative of said first layer is crosslinked.

8. The membrane of claim 6 wherein said non-porous polymer of said second layer is crosslinked.

9. The membrane of claim 1 wherein said non-porous polymer of said second layer has at least one hydrophilic functional group.

10. A method for the separation of an aqueous mixture comprising the steps of:
providing a composite membrane including a first layer and a second layer, said first layer comprising an alginic acid or a salt of an alginic acid or a salt of an alginic acid derivative, said second layer comprising a non-porous polymer having hydrophilic properties; and
contacting said mixture with said first layer.

11. The method of claim 10 wherein said aqueous mixture has a water concentration greater than 50% by weight.

12. The method of claim 11 wherein said non-porous polymer of said second layer of said composite membrane is water insoluble.

13. The method of claim 11 wherein said non-porous polymer of said second layer of said composite membrane is water soluble.

14. The method of claim 12 wherein said second layer of said composite membrane comprises a non-porous polymer selected from the group consisting of chitosan and chitosan derivatives, and cellulose and cellulose derivatives.

15. The method of claim 13 wherein said non-porous polymer of said second layer of said composite membrane is a crosslinked polyvinyl alcohol.

16. The method of claim 11 wherein said non-porous polymer of second layer of said composite membrane is chitosan.

17. The method of claim 11 wherein said alginic acid or said salt of an alginic acid or said salt of an alginic acid derivative of said first layer of said composite membrane is crosslinked.

18. The method of claim 17 wherein said non-porous polymer of said second layer of said composite membrane is crosslinked.

19. The method of claim 11 wherein said non-porous polymer of said second layer of said composite membrane has at least one hydrophilic functional group.

20. A method of preparing the composite membrane of claim 1 comprising the steps of:
casting a first film comprising an aqueous solution of an alginic acid or salt of an alginic
acid or a salt of a derivative of an alginic acid;
casting a second film comprising an aqueous solution having a non-porous polymer with
at least one hydrophilic functional group, on a surface of said first film to form a first intermediate; and
drying said first intermediate.

21. The method of claim 20 comprising the additional steps of crosslinking said alginic acid or said salt of an alginic acid or said salt of an alginic acid derivative and crosslinking said non-porous polymer.

22. The method of claim 20 wherein said non-porous polymer is a chitosan-acid salt.

23. The method of claim 22 comprising the additional steps of transforming said chitosan-acid salt into a free amine form of chitosan after drying of said first intermediate.

24. The method of claim 23 wherein said transformation is effected after drying the first intermediate by immersing the dried first intermediate in an alkaline solution to form a second intermediate, then drying said second intermediate.

25. The method of claim 24 comprising the additional steps of crosslinking said alginic acid or salt of alginic acid or said salt of an alginic acid derivative and crosslinking said chitosan.

26. The method of claim 25 wherein each of said crosslinking of said alginic acid or said salt of alginic acid and said crosslinking of said chitosan is effected by immersing the dried second intermediate in a formaldehyde solution.

27. A composite membrane as claimed in claim 1, wherein said first layer has a thickness of about 0.5 micros to about 20 microns and said second layer has a thickness of about 1.0 microns to about 40 microns.

28. The membrane of claim 27 wherein a ratio of said thickness of said first layer to said thickness of said second layer is about 1:1 to about 1:5.

29. The membrane of claim 28 wherein said non-porous polymer of said second layer is water insoluble.

30. The membrane of claim 28 wherein said non-porous polymer of said second layer is water soluble.

31. The membrane of claim 29 wherein said second layer comprises a non-porous polymer selected from the group consisting of chitosan, chitosan derivatives, and cellulose and cellulose derivatives.

32. The membrane of claim 30 wherein said non-porous polymer is a crosslinked polyvinyl alcohol.

33. The membrane of claim 28 wherein said second layer is comprised of chitosan.

34. The membrane of claim 28 wherein said alginic acid or said salt of an alginic acid or said salt of an alginic acid derivative of said first layer is crosslinked and said non-porous polymer of said second layer is crosslinked.

35. The membrane of claim 28 wherein said non-porous polymer of said second layer has at least one hydrophilic functional group.

36. A method for the separation of an aqueous mixture comprising a water concentration of greater than 50% by weight, said method comprising the steps of:
providing a composite membrane including a first layer and a second layer, said first
layer comprising an alginic acid or a salt of an alginic acid or a salt of an alginic acid
derivative, said second layer adapted to provide mechanical support and reinforcement to said first layer; and
contacting said mixture with said first layer.

37. The method of claim 36 wherein said second layer of said composite membrane is a water insoluble non-porous polymer.

38. The method of claim 36 wherein said second layer of said composite membrane is a water soluble non-porous polymer.

39. The method of claim 37 wherein said second layer of said composite membrane comprises a non-porous polymer selected from the group consisting of chitosan and chitosan derivatives, and cellulose and cellulose derivatives.

40. The method of claim 38 wherein said non-porous polymer of said second layer of said composite membrane is a crosslinked polyvinyl alcohol.

41. The method of claim 37 wherein said non-porous polymer of second layer of said composite membrane is chitosan.

42. The method of claim 36 wherein said alginic acid or said salt of a n alginic acid or said salt of an alginic acid derivative of said first layer of said composite membrane is crosslinked.

43. The method of claim 42 wherein said second layer of said composite membrane comprises a crosslinked non-porous polymer.

44. The method of claim 36 wherein said second layer of said composite membrane includes a non-porous polymer comprising at least one hydrophilic functional group.
